(19) United States
(12) Patent Application Publication
(10) Pub. No.: US 2023/0330877 A1
(43) Pub. Date: Oct. 19, 2023

(54) LIMITING COMB EXTENSION AND RETRACTION STRUCTURE OF HAIR SCISSORS

(71) Applicant: MENS GROOMER LTD, Denver, CO (US)

(72) Inventor: Qiong CHEN, Shenzhen (CN)

(21) Appl. No.: 18/339,374

(22) Filed: Jun. 22, 2023

(51) Int. Cl. B26B 19/20; B26B 19/38

(52) U.S. Cl. CPC B26B 19/205; B26B 19/3886

(57) ABSTRACT

The present disclosure relates to a limiting comb extension and retraction structure of hair scissors, including a limiting comb and an adjusting assembly which are arranged on a body of the hair scissors; the adjusting assembly includes an adjusting rotary knob and an adjusting shell; the adjusting rotary knob is horizontally placed on the body of the hair scissors; the adjusting shell is slidably arranged in the body of the hair scissors and slides synchronously with the limiting comb; a double-helix-group structure is arranged between the adjusting rotary knob and the adjusting shell; each helix group includes a boss and a spiral groove section which cooperate with each other; the boss is located on the adjusting shell; the spiral groove section is located on the adjusting rotary knob; the respective bosses are located on rotating trajectories of the corresponding spiral groove sections.

### TECHNICAL FIELD

The present disclosure relates to the field of hair scissors, and particularly, to a limiting comb extension and retraction structure of hair scissors.

### BACKGROUND

A comb on a pair of hair scissors is an auxiliary tool designed for convenience in hair cutting, which can fix a cutting length of a hair styler. In China patent CN111136694A, an assembly type hair scissors telescopic limiting assembly includes a limiting comb clamping sleeve and an adjusting assembly. The limiting comb clamping sleeve includes limiting comb teeth and a first through hole. The limiting comb teeth are arranged at intervals; a first cavity for placing a tool bit is arranged in the region of the limiting comb teeth; and a second cavity for placing the adjusting assembly is arranged in the region of the first through hole. The adjusting assembly includes a rotary knob, an adjusting disc, and an adjusting shell; the adjusting disc includes an arc-shaped guide slot and a second through hole; the arc-shaped guide slot is arranged around the second through hole; one end of the arc-shaped guide slot is arranged at an edge of the second through hole, and the other end is arranged at a bottom edge of the adjusting disc; the rotary knob extends out of the first through hole after being connected to the second through hole through a fixing member; and the rotary knob is pulled to drive the adjusting disc to rotate. The adjusting shell abuts against the second cavity, is in contact with an edge of the second cavity, and extends in a direction of the edge of the second cavity. The adjusting shell is also provided with a positioning protrusion and fasteners. A size of the positioning protrusion matches a width of the arc-shaped guide slot. The positioning protrusion is used for resisting against the arc-shaped guide slot and driving the limiting comb clamping sleeve to move up and down, and the fasteners are arranged on both sides of the adjusting shell in a lengthwise direction. Gaps are arranged on the fasteners. The fasteners are used for mounting the entire telescopic limiting assembly on a hair scissors body. When in use, the adjusting disc is driven to rotate by the horizontally placed rotary knob, and the positioning protrusion resists against the arc-shaped guide slot on the adjusting disc to drive the limiting comb clamping sleeve to move up and down. However, there are defects in the adjusting structure of this comb. Only a single arc-shaped guide slot is formed in the adjusting dis. Due to a limited trajectory length of each arc-shaped guide slot, only one positioning protrusion is used to resist against the arc-shaped guide slot to drive the limiting comb clamping sleeve to move up and down. The limiting comb clamping sleeve ultimately only slides and moves one distance a, which will limit a movement distance of the limiting comb clamping sleeve.

### SUMMARY

To overcome the defects in the prior art, the present disclosure provides a limiting comb extension and retraction structure of hair scissors. By the design of a double-helix-group structure, a movement distance of a limiting comb is increased.

The technical solution of the present disclosure is as follows: A limiting comb extension and retraction structure of hair scissors includes a limiting comb and an adjusting assembly which are arranged on a body of the hair scissors,
wherein the limiting comb can slide along a tooth length direction of comb teeth;
the adjusting assembly includes an adjusting rotary knob and an adjusting shell; the adjusting rotary knob is horizontally arranged on the body of the hair scissors and can also rotate relative to the body of the hair scissors; the adjusting shell is slidably arranged in the body of the hair scissors and slides synchronously with the limiting comb;
a double-helix-group structure (including a first helix group and a second helix group) is arranged between the adjusting rotary knob and the adjusting shell to convert rotation of the adjusting rotary knob into sliding of the adjusting shell; each helix group includes a boss and a spiral groove section which cooperate with each other; the bosses are located on the adjusting shell; the spiral groove sections are located on the adjusting rotary knob; the spiral groove sections are arranged around a center of the adjusting rotary knob, and extends in an arc-shaped manner from an outer edge of the adjusting rotary knob towards the center; an opening in one end of each spiral groove section is an inlet/outlet; the inlet/outlet end of one spiral groove section is close to the outer edge of the adjusting rotary knob, and the inlet/outlet end of the other spiral groove section is close to the center of the adjusting rotary knob; the various bosses are located on rotating trajectories of the corresponding spiral groove sections, and enter and leave the spiral groove sections relatively;
the adjusting rotary knob rotates; after the boss in the first helix group resists against the spiral groove section to drive the limiting comb to move a distance a, the boss of the first helix group slides out of the spiral groove section, and the boss in the second helix group slides into the spiral groove section; and the boss in the second helix group resists against the spiral groove section to drive the limiting comb to continue to move a distance b.

By the adoption of the above technical solution, on the basis of the existing structures of the adjusting rotary knob and the adjusting shell, the double-helix-group structure is designed, thereby increasing a movement distance of the limiting comb.

During use, the adjusting rotary knob is stressed to rotate. After the boss in the first helix group resists against the spiral groove section to drive the limiting comb to move the distance a, the boss in the second helix group resists against the spiral groove section to drive the limiting comb to continue to move the distance b. The limiting comb can further continue to move b on the basis of the only movement a achieved by the original one helix group, and the adjustable movement distance of the limiting comb is increased.

In a further setting of the present disclosure, the two bosses and a central portion of the adjusting rotary knob are located on the same plane.

By the adoption of the above technical solution, the bosses are correspondingly arranged on the same plane of the central portion of the adjusting rotary knob, which facilitates co-use with the corresponding spiral groove sections.

In a further setting of the present disclosure, an inner ring/outer ring of the inlet/outlet end of each spiral groove section further extends to form a guide plate.

By the adoption of the above technical solution, the guide plate can play a role of guiding the bosses to get in and get out.

In a further setting of the present disclosure, a motor case sleeve is arranged in the body of the hair scissors; the adjusting shell is slidably arranged on the motor case sleeve; a guide structure is arranged between corresponding wall surfaces of the motor case sleeve and the adjusting shell; and the guide structure achieves sliding guidance on the adjusting shell in the tooth length direction of the comb teeth of the limiting comb.

By the adoption of the above technical solution, on the one hand, the motor case sleeve can be used for mounting a motor; and on the other hand, it is convenient for arranging the guide structure between the motor case sleeve and the adjusting shell, thereby achieving the sliding guidance on the adjusting shell.

In a further setting of the present disclosure, the limiting comb and the adjusting shell are in clamping fit.

Preferably, the limiting comb is located at a head portion of the body of the hair scissors; a pin jack is further arranged on the head portion of the body of the hair scissors; the limiting comb is provided with pins; the adjusting shell is provided with side wings; tail ends of the pins are plugged into a chamber of the body of the hair scissors after passing through the pin jack and are clamped on cylinders protruding on the side wings.

By the adoption of the above technical solution, the clamping fit is convenient for mounting, removal, and replacement of the limiting comb.

In a further setting of the present disclosure, a rotating handfeel structure is arranged between the adjusting rotary knob and the body of the hair scissors; the rotating handfeel structure includes a toothed ring and a pick which are used cooperatively; the pick is pressed to cause elastic deformation; and when the adjusting rotary knob is stressed to rotate, the pick is switched between all tooth grooves on the toothed ring.

By the adoption of the above technical solution, when the adjusting rotary knob rotates, the pick is switched between all the tooth grooves on the toothed ring, to achieve a shift handfeel and reminding.

In a further setting of the present disclosure, each tooth groove on the toothed ring is “V”-shaped; the pick is further provided with a “V”-shaped poking head formed by bending a sheet body; and the poking head is switched between the tooth grooves on the toothed ring.

The pick is further provided with leg portions extending from two ends of the “V”-shaped poking head and used for mounting.

By the adoption of the above technical solution, the “V”-shaped poking head is conveniently stressed to deform to enter and leave the tooth grooves, and the extending leg portions facilitate the mounting of the pick.

In a further setting of the present disclosure, a through hole is formed in the center of the adjusting rotary knob; the body of the hair scissors is provided with a central pillar threaded in the through hole; the adjusting rotary knob is rotatably mounted on the central pillar; the toothed ring is located on the inner ring of the adjusting rotary knob concentric with the through hole; and the pick is located in a ring encircled by the toothed ring.

By the adoption of the above technical solution, the structural design is simple; an internal space of the adjusting rotary knob is reasonably used to arrange the toothed ring and accommodate the pick.

In a further setting of the present disclosure, an indicating disc is mounted on the body of the hair scissors; the indicating disc is located in the center of the adjusting rotary knob; the adjusting rotary knob is provided with a movement indicating ring encircled by several movement indicators distributed in a circumferential direction at equal intervals; and the indicating disc is provided with a pointer used for indicating a corresponding movement indicator to express a current movement degree of the limiting comb.

By the adoption of the above technical solution, when the adjusting rotary knob rotates, the different movement indicators on the adjusting rotary knob correspond to the pointer on the indicating disc to express the current movement degree of the limiting comb.

### BRIEF DESCRIPTION OF THE DRAWINGS

FIG. 1 is a structural diagram of hair scissors according to a specific embodiment of the present disclosure;

FIG. 2 is a schematic diagram of a limiting comb extension and retraction structure according to a specific embodiment of the present disclosure;

FIG. 3 is a collaboration diagram of an adjusting shell and a motor case sleeve according to a specific embodiment of the present disclosure;

FIG. 4 is a first schematic diagram of a state of a double-helix-group structure according to a specific embodiment of the present disclosure, wherein s-a is a rotating direction of an adjusting rotary knob, and s-b is a movement direction of a boss;

FIG. 5 is a second schematic diagram of a state of a double-helix-group structure according to a specific embodiment of the present disclosure;

FIG. 6 is a third schematic diagram of a state of a double-helix-group structure according to a specific embodiment of the present disclosure;

FIG. 7 is a collaboration diagram of an indicating disc and an adjusting rotary knob according to a specific embodiment of the present disclosure;

FIG. 8 is a schematic diagram of a rotating handfeel structure according to a specific embodiment of the present disclosure;

FIG. 9 is a structural diagram of a pick according to a specific embodiment of the present disclosure;

FIG. 10 is an assembling diagram of a pick and an indicating disc according to a specific embodiment of the present disclosure;

FIG. 11 is a structural diagram of a limiting comb according to a specific embodiment of the present disclosure; and

FIG. 12 is a structural diagram of a body of hair scissors according to a specific embodiment of the present disclosure.

In the drawings: limiting comb 1, adjusting assembly 2, comb tooth 11, adjusting rotary knob 21, adjusting shell 22, first helix group A-1, second helix group A-2, boss A11, spiral groove section A12, inlet/outlet A121, guide plate A122, motor case sleeve 3, guide structure B, pin jack 9, pin 12, side wing 221, cylinder 2211, toothed ring C1, pick C2, tooth groove C11, poking head C21, leg portion C22, through hole 211, central pillar 10, indicating disc 4, movement indicator 131, movement indicating ring 13, pointer 41, and clamping slot 121.

### DETAILED DESCRIPTION OF THE EMBODIMENTS

The technical solutions in this embodiment of the present disclosure will be clearly and completely described below in conjunction with the accompanying drawings. Apparently, the described embodiments are only a part of the embodiments of the present disclosure, rather than all the embodiments. Based on the embodiments in the present disclosure, all other embodiments obtained by those of ordinary skill in the art without creative work shall fall within the protection scope of the present disclosure.

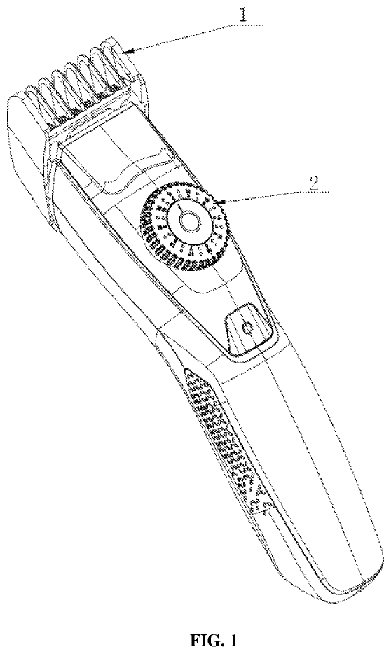

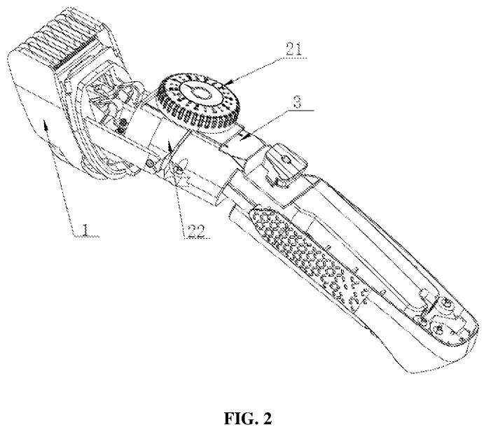

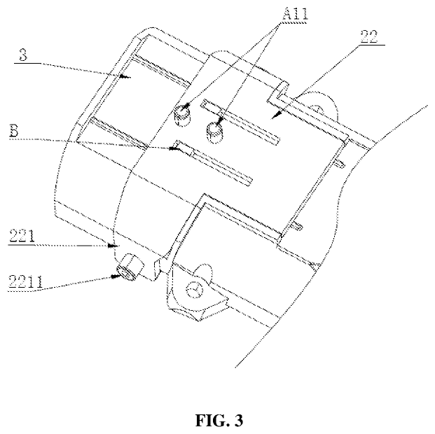

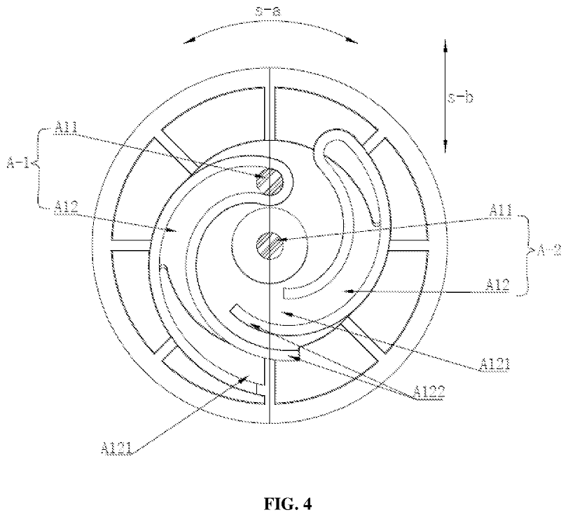

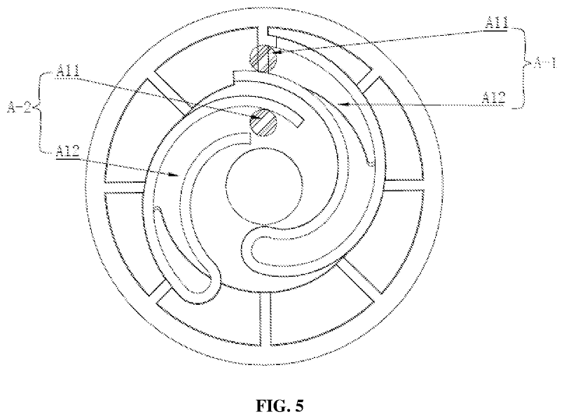

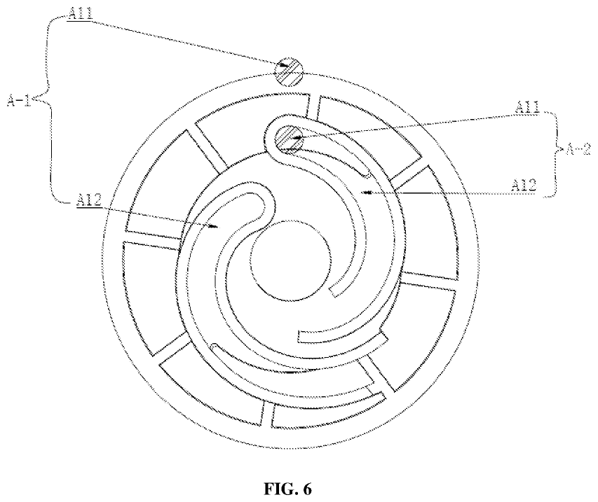

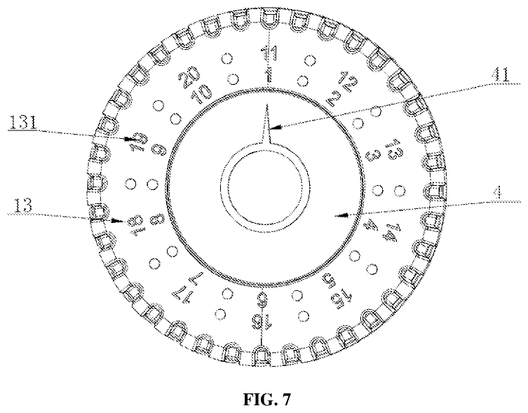

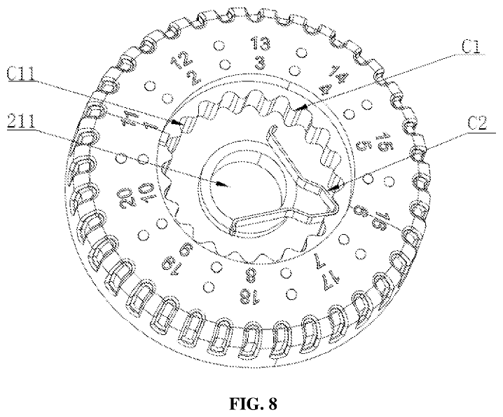

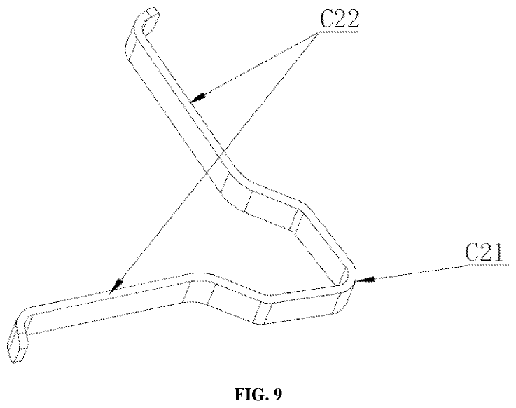

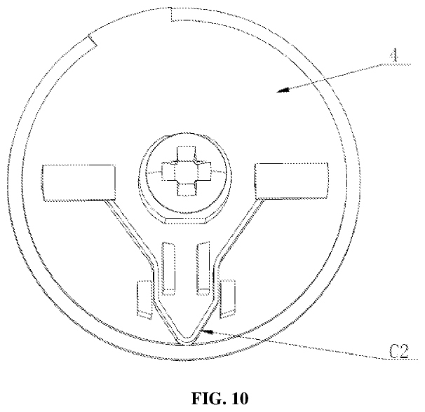

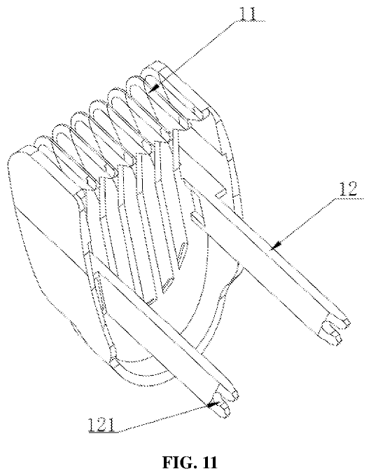

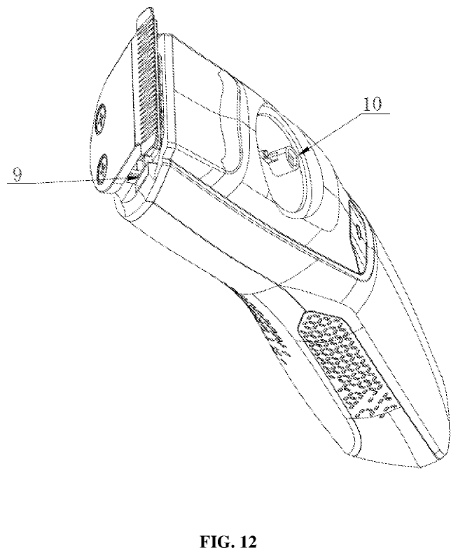

As shown in FIG. 1 to FIG. 12, a limiting comb extension and retraction structure of hair scissors includes a limiting comb 1 and an adjusting assembly 2 which are arranged on a body of the hair scissors.

The limiting comb 1 can slide along a tooth length direction of comb teeth 11.

The adjusting assembly 2 includes an adjusting rotary knob 21 and an adjusting shell 22. The adjusting rotary knob 21 is horizontally arranged on the body of the hair scissors and can also rotate relative to the body of the hair scissors. The adjusting shell 22 is slidably arranged in the body of the hair scissors and slides synchronously with the limiting comb 1.

A double-helix-group structure (including a first helix group A-1 and a second helix group A-2) is arranged between the adjusting rotary knob 21 and the adjusting shell 22 to convert rotation of the adjusting rotary knob 21 into sliding of the adjusting shell 22. Each helix group includes a boss A11 and a spiral groove section A12 which cooperate with each other. The bosses A11 are located on the adjusting shell 22. The spiral groove sections A12 are located on the adjusting rotary knob 21. The spiral groove sections A12 are arranged around a center of the adjusting rotary knob 21, and extends in an arc-shaped manner from an outer edge of the adjusting rotary knob 21 towards the center. An opening in one end of each spiral groove section A12 is an inlet/outlet A121. The inlet/outlet end of one spiral groove section A12 is close to the outer edge of the adjusting rotary knob 21, and the inlet/outlet end of the other spiral groove section A12 is close to the center of the adjusting rotary knob 21. The various bosses A11 are located on rotating trajectories of the corresponding spiral groove sections A12, and enter and leave the spiral groove sections A12 relatively.

The adjusting rotary knob 21 rotates. After the boss A11 in the first helix group A-1 resists against the spiral groove section A12 to drive the limiting comb 1 to move a distance a, the boss A11 of the first helix group A-1 slides out of the spiral groove section A12, and the boss A11 in the second helix group A-2 slides into the spiral groove section A12; and the boss A11 in the second helix group A-2 resists against the spiral groove section A12 to drive the limiting comb 1 to continue to move a distance b.

Specifically, the two bosses A11 and a central portion of the adjusting rotary knob 21 are located on the same plane. The two bosses A11 are distributed at the front and the back. The boss A11 in the first helix group A-1 is at the front, and the inlet/outlet end of the spiral groove section A12 is close to the outer edge of the adjusting rotary knob 21. The boss A11 in the second helix group A-2 is at the back, and the inlet/outlet end of the spiral groove section A12 is close to the center of the adjusting rotary knob 21. Of course, the first helix group A-1 and the second helix group A-2 can also be interchanged.

Specifically, an inner ring/outer ring of the inlet/outlet end of each spiral groove section A12 further extends to form a guide plate A122.

Specifically, a motor case sleeve 3 is arranged in the body of the hair scissors; the adjusting shell 22 is slidably arranged on the motor case sleeve 3; a guide structure B is arranged between corresponding wall surfaces of the motor case sleeve 3 and the adjusting shell 22; and the guide structure B achieves sliding guidance on the adjusting shell 22 in the tooth length direction of the comb teeth of the limiting comb 1. The guide structure B can be a guide slot and guide block structure, and a guide slot is arranged in the tooth length direction of the comb teeth.

According to the present disclosure, on the basis of the existing structures of the adjusting rotary knob 21 and the adjusting shell 11, the double-helix-group structure is designed, thereby increasing a movement distance of the limiting comb 1.

During use, the adjusting rotary knob 21 is stressed to rotate towards one side to push the limiting comb 1 to extend out forwards. First, the boss A11 in the first helix group A-1 resists against the spiral groove section A12, and the spiral groove section A12 in the first helix group A-1 rotates outwards to drive the boss A11 located therein to move forwards. After the limiting comb 1 moves the distance a forwards, the boss A11 of the first helix group A-1 slides out from the inlet/outlet A121 of the spiral groove section A12, and the boss A11 in the second helix group A-2 slides in from the inlet/outlet A121 of the spiral groove section A12. Next, the boss A11 in the second helix group A-2 resists against the spiral groove section A12, and the spiral groove section A12 in the second helix group A-2 rotates outwards to drive the boss A11 located therein to move forwards, so that the limiting comb 1 can at most move the distance b forwards to an extreme position.

The adjusting rotary knob 21 is stressed to rotate towards the other side to drive the limiting comb 1 to retract backwards. First, the boss A11 in the second helix group A-2 resists against the spiral groove section A12, and the spiral groove section A12 in the second helix group A-2 rotates inwards to drive the boss A11 located therein to move backwards. After the limiting comb 1 moves the distance b backwards, the boss A11 of the second helix group A-2 slides out from the inlet/outlet A121 of the spiral groove section A12, and the boss A11 in the first helix group A-1 slides in from the inlet/outlet A121 of the spiral groove section A12. Next, the boss A11 in the first helix group A-1 resists against the spiral groove section A12, and the spiral groove section A12 in the first helix group A-1 rotates inwards to drive the boss A11 located therein to move backwards, so that the limiting comb 1 can at most move the distance a backwards to an extreme position.

By the adoption of the above technical solution, the bosses A 11 are correspondingly arranged on the same plane of the central portion of the adjusting rotary knob 21, which facilitates co-use with the corresponding spiral groove sections A12.

By the adoption of the above technical solution, the guide plate A122 can play a role of guiding the bosses A11 to get in and get out.

By the adoption of the above technical solution, on the one hand, the motor case sleeve 3 can be used for mounting a motor; and on the other hand, it is convenient for arranging the guide structure between the motor case sleeve and the adjusting shell 22, thereby achieving the sliding guidance on the adjusting shell 22.

In a specific embodiment of the present disclosure, the limiting comb 1 and the adjusting shell 22 are in clamping fit.

Specifically, the limiting comb 1 is located at a head portion of the body of the hair scissors. A pin jack 9 is further arranged on the head portion of the body of the hair scissors. The limiting comb 1 is provided with pins 12. The adjusting shell 22 is provided with side wings 221. Tail ends of the pins 12 are plugged into a chamber of the body of the hair scissors after passing through the pin jack 9 and are clamped on cylinders 2211 protruding on the side wings 221. The tail end of each pin 12 is provided with a clamping slot 121 for plugging each cylinder 2211. Each clamping slot 121 has a V-shaped notch.

By the adoption of the above technical solution, the clamping fit between the limiting comb 1 and the adjusting shell 22 is convenient for mounting, removal, and replacement of the limiting comb 1.

In a specific embodiment of the present disclosure, a rotating handfeel structure is arranged between the adjusting rotary knob 21 and the body of the hair scissors; the rotating handfeel structure includes a toothed ring C1 and a pick C2 which are used cooperatively; the pick C2 is pressed to cause elastic deformation; and when the adjusting rotary knob 21 is stressed to rotate, the pick C2 is switched between all tooth grooves C11 on the toothed ring C1.

Specifically, each tooth groove C11 on the toothed ring C1 is “V”-shaped; the pick C2 is further provided with a “V”-shaped poking head C21 formed by bending a sheet body; and the poking head C21 is switched between the tooth grooves C11 on the toothed ring C1.

The pick C2 is further provided with leg portions C22 extending from two ends of the “V”-shaped poking head C21 and used for mounting.

Specifically, a through hole 211 is formed in the center of the adjusting rotary knob 21; the body of the hair scissors is provided with a central pillar 10 threaded in the through hole 211; the adjusting rotary knob 21 is rotatably mounted on the central pillar 10; the toothed ring C1 is located on the inner ring of the adjusting rotary knob 21 concentric with the through hole 211; and the pick C2 is located in a ring encircled by the toothed ring C1. Of course, the toothed ring C1 can also be located on a back surface of the adjusting rotary knob 21. The central pillar 10 is located in a center of an adjusting rotary knob mounting region on the body of the hair scissors.

Specifically, an indicating disc 4 is mounted on the body of the hair scissors; the indicating disc 4 is located in the center of the adjusting rotary knob 21; a surface of the adjusting rotary knob 21 is provided with a movement indicating ring 13 encircled by several movement indicators 131 distributed in a circumferential direction at equal intervals; and the indicating disc 4 is provided with a pointer 41 used for indicating a corresponding movement indicator 131 to express a current movement degree of the limiting comb 1. The movement indicators 131 can be directly expressed by digits, or expressed by different color numbers, and can directly reflect a movement distance of the limiting comb 1 or reflect a degree of movement of the limiting comb 1. The pick C2 is mounted on the indicating disc 4, and the two leg portions C22 of the pick C2 are plugged into slots formed in the indicating disc 4. The movement indicators 131 can be in a one-to-one correspondence or interval correspondence to the tooth grooves of the toothed ring.

The design of the rotating handfeel structure of the present disclosure is simple; an internal space of the adjusting rotary knob 21 is reasonably used to arrange the toothed ring C1 and accommodate the pick C2.

When the adjusting rotary knob 21 rotates, the “V-shaped” poking head C21 of the pick C2 is switched between all the tooth grooves C11 on the toothed ring C1 to achieve a shift handfeel and reminding. The “V”-shaped poking head C21 is conveniently stressed to deform to enter and leave the tooth grooves C11, and the extending leg portions C22 facilitate the mounting of the pick C2.

When the adjusting rotary knob 21 rotates, the different movement indicators 131 on the adjusting rotary knob correspond to the pointer 41 on the indicating disc 4 to express the current movement degree of the limiting comb 1.

It should be noted that all directional indications (such as front, back . . . ) in the description of the present disclosure are only used to explain a relative positional relationship between components, motion situations, etc. at a certain specific attitude (as shown in the figures). If the specific attitude changes, the directional indication also correspondingly changes.

In addition, the descriptions of “first”, “second”, etc. in the present disclosure are only used for descriptive purposes, and cannot be understood as indicating or implying its relative importance or implicitly indicating the number of technical features indicated. In the description of the present disclosure, unless expressly specified otherwise, the meaning of the “several” is at least two, such as two and three.

In the description of the present disclosure, unless otherwise clearly specified and defined, the terms “mount”, “connect”, “couple”, “connection”, and “fix” should be understood in a broad sense. For example, it can be a fixed connection, a detachable connection, integration, a mechanical connection, an electrical connection, a direct connection, an indirect connection through an intermediate medium, an intercommunication between two elements, or an interaction between two elements. Those of ordinary skill in the art can understand the specific meanings of the above terms in the present disclosure according to specific situations.

What is claimed is:

1. A limiting comb extension and retraction structure of hair scissors, comprising a limiting comb (1) and an adjusting assembly (2) which are arranged on a body of the hair scissors,
wherein the limiting comb (1) slides along a tooth length direction of comb teeth (11);
the adjusting assembly (2) comprises an adjusting rotary knob (21) and an adjusting shell (22); the adjusting rotary knob (21) is horizontally arranged on the body of the hair scissors and rotates relative to the body of the hair scissors; the adjusting shell (22) is slidably arranged in the body of the hair scissors and slides synchronously with the limiting comb (1);
a double-helix-group structure (comprising a first helix group A-1 and a second helix group A-2) is arranged between the adjusting rotary knob (21) and the adjusting shell (22) to convert rotation of the adjusting rotary knob (21) into sliding of the adjusting shell (22); each helix group comprises a boss (A11) and a spiral groove section (A12) which cooperate with each other; the bosses (A11) are located on the adjusting shell (22); the spiral groove sections (A12) are located on the adjusting rotary knob (21); the spiral groove sections (A12) are arranged around a center of the adjusting rotary knob (21), and extends in an arc-shaped manner from an outer edge of the adjusting rotary knob (21) towards the center; an opening in one end of each spiral groove section (A12) is an inlet/outlet (A121); the inlet/outlet end of one spiral groove section (A12) is close to the outer edge of the adjusting rotary knob (21), and the inlet/outlet end of the other spiral groove section (A12) is close to the center of the adjusting rotary knob (21); the various bosses (A11) are located on rotating trajectories of the corresponding spiral groove sections (A12), and enter and leave the spiral groove sections (A12) relatively;
the adjusting rotary knob (21) rotates; after the boss (A11) in the first helix group (A-1) resists against the spiral groove section (A12) to drive the limiting comb (1) to move a distance a, the boss (A11) of the first helix group (A-1) slides out of the spiral groove section (A12), and the boss (A11) in the second helix group (A-2) slides into the spiral groove section (A12); and the boss (A11) in the second helix group (A-2) resists against the spiral groove section (A12) to drive the limiting comb (1) to continue to move a distance b.

2. The limiting comb extension and retraction structure of the hair scissors according to claim 1, wherein the two bosses (A11) and a central portion of the adjusting rotary knob (21) are located on the same plane.

3. The limiting comb extension and retraction structure of the hair scissors according to claim 1, wherein an inner ring/outer ring of the inlet/outlet end of each spiral groove section (A12) further extends to form a guide plate (A122).

4. The limiting comb extension and retraction structure of the hair scissors according to claim 1, wherein a motor case sleeve (3) is arranged in the body of the hair scissors; the adjusting shell (22) is slidably arranged on the motor case sleeve (3); a guide structure (B) is arranged between corresponding wall surfaces of the motor case sleeve (3) and the adjusting shell (22); and the guide structure (B) achieves sliding guidance on the adjusting shell (22) in the tooth length direction of the comb teeth of the limiting comb (1).

5. The limiting comb extension and retraction structure of the hair scissors according to claim 1, wherein the limiting comb (1) and the adjusting shell (22) are in clamping fit.

6. The limiting comb extension and retraction structure of the hair scissors according to claim 5, wherein the limiting comb (1) is located at a head portion of the body of the hair scissors; a pin jack (9) is further arranged on the head portion of the body of the hair scissors; the limiting comb (1) is provided with pins (12); the adjusting shell (22) is provided with side wings (221); tail ends of the pins (12) are plugged into a chamber of the body of the hair scissors after passing through the pin jack (9) and are clamped on cylinders (2211) protruding on the side wings (221).

7. The limiting comb extension and retraction structure of the hair scissors according to claim 1, wherein a rotating handfeel structure is arranged between the adjusting rotary knob (21) and the body of the hair scissors; the rotating handfeel structure comprises a toothed ring (C1) and a pick (C2) which are used cooperatively; the pick (C2) is pressed to cause elastic deformation; and when the adjusting rotary knob (21) is stressed to rotate, the pick (C2) is switched between all tooth grooves (C11) on the toothed ring (C1).

8. The limiting comb extension and retraction structure of the hair scissors according to claim 7, wherein each tooth groove (C11) on the toothed ring (C1) is “V”-shaped; the pick (C2) is further provided with a “V”-shaped poking head (C21) formed by bending a sheet body; the poking head (C21) is switched between the tooth grooves (C11) on the toothed ring (C1); and
the pick (C2) is further provided with leg portions (C22) extending from two ends of the “V”-shaped poking head (C21) and used for mounting.

9. The limiting comb extension and retraction structure of the hair scissors according to claim 7, wherein a through hole (211) is formed in the center of the adjusting rotary knob (21); the body of the hair scissors is provided with a central pillar (10) threaded in the through hole (211); the adjusting rotary knob (21) is rotatably mounted on the central pillar (10); the toothed ring (C1) is located on the inner ring of the adjusting rotary knob (21) concentric with the through hole (211); and the pick (C2) is located in a ring encircled by the toothed ring (C1).

10. The limiting comb extension and retraction structure of the hair scissors according to claim 1, wherein an indicating disc (4) is mounted on the body of the hair scissors; the indicating disc (4) is located in the center of the adjusting rotary knob (21); a surface of the adjusting rotary knob (21) is provided with a movement indicating ring (13) encricled by several movement indicators (131) distributed in a circumferential direction at equal intervals; and the indicating disc (4) is provided with a pointer (41) used for indicating a corresponding movement indicator (131) to express a current movement degree of the limiting comb (1).
